(19) United States
(12) Patent Application Publication
(10) Pub. No.: US 2016/0062354 A1
(43) Pub. Date: Mar. 3, 2016

(54) KIT FOR THE CABLE-FREE CONTROL OF A MANOEUVRING DRIVE SYSTEM FOR A VEHICLE, A MANOEUVRING DRIVE SYSTEM AND A VEHICLE

(71) Applicant: CARMAN ENTERPRISE CO., LTD., Hanghzou (CN)

(72) Inventor: Xianwei LI, Hangzhou (CN)

(73) Assignee: CARMAN ENTERPRISE CO., LTD.

(21) Appl. No.: 14/822,141

(22) Filed: Aug. 10, 2015

(30) Foreign Application Priority Data
Aug. 26, 2014 (DE) 202014103988.0

(51) Int. Cl. G05D 1/00; H04W 4/00

(52) U.S. Cl. CPC G05D 1/0016; H04W 4/008

(57) ABSTRACT

A kit for the cable-free control of a manoeuvring drive system for a vehicle, in particular a vehicle without its own drive, the manoeuvring drive system having at least two drive units and a control device connected to the drive units, comprising a communication module which is designed to receive commands for control of the drive units in a cable-free manner, fastening means for fastening the communication module to the vehicle, in particular on the outside of the vehicle, and preferably on the bottom of the vehicle, and connection means for connecting the communication module to the control device so that the commands received, cable-free, for control of the drive units can be transmitted from the communication module to the control device. Moreover, the invention relates to a vehicle, in particular to a vehicle without its own drive, and to a manoeuvring drive system for the latter.

### CROSS-REFERENCE TO RELATED APPLICATIONS AND CLAIM TO PRIORITY

This application claims priority to Patent Application No. 202014103988.0 filed Aug. 26, 2014 in Germany, the disclosure of which is incorporated herein by reference and to which priority is claimed.

### FIELD OF THE INVENTION

The invention relates to a kit for the cable-free control of a manoeuvring drive system for a vehicle, in particular a vehicle without its own drive, the manoeuvring drive system having at least two drive units and a control device connected to the drive units. Moreover, the invention relates to a vehicle, in particular a vehicle without its own drive, and to a manoeuvring drive system for the latter.

### BACKGROUND OF THE INVENTION

Vehicles without their own drive can be, for example, trailers such as, for example, caravans, boat or horse trailers or the like. With such vehicles it is considered to be problematic that the latter can only be moved away manually if they are not connected to the towing vehicle, e.g. a car, and this is difficult. With a caravan, for example, that has been uncoupled from the car by means of which it has been transported at an appropriate place on a campsite, manoeuvring manually into the finally parking position is associated with a great deal of effort for the driver.

In order to facilitate a manoeuvring procedure in the uncoupled state, manoeuvring drive systems have been developed which can be fitted on a vehicle without its own drive. This type of manoeuvring drive system generally comprises at least two drive units by means of which the wheels of the vehicle to be manoeuvred can be set in rotation. The drive units are fitted onto the outside of the vehicle, generally in a region directly in front of or behind the wheels which are to drive the drive units. The drive units respectively comprise a rotatable drive element which is brought into frictionally engaged contact with a wheel of the vehicle so that rotation of the drive element brings about rotation of the wheel of the vehicle. A motor, by means of which rotation is caused in the clockwise or in the anticlockwise direction, is assigned to each drive element. If this type of drive unit is fitted in a single-axle vehicle in the region of each of the two wheels, or in a two- or multi-axle vehicle in the region of each wheel of at least one of the axles, the vehicle can be manoeuvred easily by a user by means of the drive units.

For the control of the motors of the drive units, the known manoeuvring drive systems generally comprise a control device with appropriate electronics. In contrast to the drive units, which are fitted in the region of the wheels on the outside of the vehicle, the control device is provided in the dry interior of the vehicle. If a manoeuvring drive system is used on a caravan, the control device is fitted in particular underneath a seat or on a bed shelf in the caravan interior.

The control device is connected by appropriate cables on the one hand to each of the two drive units, and on the other hand to a voltage source. A battery provided within the vehicle, for example, can be used as this source. Advantageously, the control device is positioned close to the battery. The motors of the drive units are supplied with electrical energy by the control device connected to the battery.

A user can control the drive units by means of an operating device, in particular without cables. For this purpose, the operating device comprises a control pad which advantageously has buttons or pads that can be activated by finger pressure and by means of which the operator can selectively set the drive units, and so the vehicle, in motion. In particular, keys or pads are provided by means of which a forwards or backwards motion of the vehicle can be brought about, as well as cornering to the left or to the right in the forwards or backwards direction.

Known operating devices are generally configured as remote controls which the user can hold in the hand and so control the vehicle easily from a position close to the vehicle. The remote controls are configured to transmit manoeuvring commands inputted by the user to the control device cable-free.

With the known manoeuvring drive systems which can be operated by means of operating devices in the form of remote controls without cables it is partially considered as a disadvantage that the cable-free transmission of the manoeuvring commands to the control device does not always take place reliably.

### SUMMARY OF THE INVENTION

On the basis of this prior art, it is an object of the present invention to further develop a manoeuvring drive system of the known type such that reliable, cable-free communication between the operating device and the control device is guaranteed at all times.

This object is achieved by a kit for the cable-free control of a manoeuvring drive system for a vehicle, in particular a vehicle without its own drive, the manoeuvring drive system having at least two drive units and a control device connected to the drive units, comprising:

a communication module which is designed to receive commands for control of the drive units in a cable-free manner,

fastening means for fastening the communication module to the vehicle, in particular on the outside of the vehicle, and preferably on the bottom of a vehicle, and

connection means for connecting the communication module to the control device so that the commands received, cable-free, for control of the drive units can be transmitted from the communication module to the control device.

In other words, the central idea behind the present invention consists of making available a kit for the cable-free control of a manoeuvring drive system which comprises a separate communication module.

The kit further comprises fastening means for fastening the communication module to the vehicle, in particular from the outside, e.g. to the bottom of the vehicle. All known means that are appropriate for fixing the communication module detachably or also permanently to the vehicle can be used as fastening means. The fastening means can include, for example, screws which are screwed into a wall of the vehicle through openings which are provided in a housing of the communication module. Alternatively, the communication module can be provided on the vehicle by means of appropriate adhesives. If the communication module is fastened to the outside of the vehicle, weather-resistant fastening means are advantageously used.

In a manner known in its own right, the communication module comprises in particular a receiver for cable-free data reception. For the cable-free transmission of manoeuvring commands from the operating device to the communication module, any known standard for wireless data exchange can be used.

In addition to the communication module and the fastening means the kit according to the invention further comprises connection means by means of which the communication module provided, in particular, on the outside of the vehicle, can be connected to the control device of the manoeuvring drive system in the vehicle interior. The connection means are designed such that manoeuvring commands, which have been sent, cable-free, by the operating device and are received by the communication module, can be transferred to the control device. Furthermore, the connection means are advantageously configured such that they make it possible to supply voltage to the communication module via the control device which is generally connected to a voltage source. Alternatively or in addition, the communication module can have its own voltage source in the form of a battery.

The connection means comprise in particular at least one suitable cable by means of which a communicative connection between the communication module and the control device can be established and the supply of voltage to the communication module can be guaranteed.

A communication module which, according to the invention, is physically separated from the control device, can structurally enable cable-free communication between the control device and the operating device. In particular, the kit according to the invention can be very easily retrofitted to vehicles that are already equipped with a manoeuvring drive system. For this purpose the communication module is provided simply on the vehicle, in particular on the outside, and is connected to the control device which is already present in the vehicle interior by the connection means. Retrofitting can be according to any wireless communication standard, for which purpose a correspondingly configured communication module is simply used.

If the communication module is fastened to the outside of the vehicle and is connected to the control device provided in the vehicle interior by the connection means, it is additionally guaranteed that any shielding by the housing of the vehicle, which generally comprises metallic parts to a large extent or is made entirely of metal, is totally avoided. Consequently, the cable-free transmission of data between the operating device and the control device of the manoeuvring drive system can take place particularly reliably, and a user can control the vehicle, cable-free, at all times without interruptions occurring in the transfer of commands between the operating device and the control device.

In one advantageous embodiment of the kit according to the invention provision is made such that the communication module is designed to receive the commands for control of the drive units in a cable-free manner via Bluetooth. The Bluetooth standard has proven to be particularly suitable for enabling the cable-free transmission of manoeuvring commands from the operating device to the communication module. Bluetooth is a known communication protocol which reliably guarantees cable-free data transmission between devices over comparably short distances. Moreover, there are a plurality of devices which are capable of enabling data transfer via Bluetooth.

Another embodiment of the kit according to the invention is characterised in that a temperature- and/or weather-resistant housing is assigned to the communication module. This is advantageous if the communication module is fastened to the outside of the vehicle. According to this embodiment the communication module is surrounded by a housing which protects it from the weather conditions and from comparably high or comparably low temperatures. Provision can be made here such that the communication module itself has a temperature- and/or weather-resistant housing. Alternatively, a temperature- and/or weather-resistant housing, into which the communication module can be introduced or inserted as required, can be provided on the vehicle from the outside. In this case, the fastening means of the kit according to the invention serve in particular to fix the temperature- and/or weather-resistant housing onto the vehicle. In this case the communication module can be used, for example, only for the duration of a manoeuvre into the housing and can be connected to the control device. If the manoeuvre is complete, the communication module can be removed from the housing in order to be protected against theft and damage.

In a further development of the invention provision is made such that the kit further comprises an operating device which is formed such that a user can input commands for control of the drive units into the operating device and that the inputted commands are transmitted, cable-free, to the communication module. This type of operating device makes it possible for a user to operate the drive units of the manoeuvring drive system easily without any cable.

In this connection the operating device can be designed to transmit the inputted commands to the communication module via Bluetooth. This configuration is advantageous if the communication module is also configured to enable communication via Bluetooth. The manoeuvring commands for the drive units can then be transmitted between the operating device and the communication module via Bluetooth.

According to one particularly preferred embodiment the kit according to the invention further comprises an app for a smartphone or a tablet PC which is designed to enable a user to control the drive units, wireless, via a smartphone or a tablet PC. The app is application software which makes it possible to control the drive units.

In an advantageous configuration the operating device here can be a smartphone or a tablet PC in which the app is installed.

This configuration has proven to be particularly advantageous because it is made possible for a user to control the drive units of the manoeuvring drive system by means of his/her smartphone or tablet PC. For this purpose a special app is made available which is configured so that control of the drive units can take place via the smartphone or the tablet PC, in particular via the touchscreen or also via voice control. If a touchscreen is used, within the framework of the app in particular an appropriate control pad is shown on the latter. The control pad shown advantageously simulates the operating devices known from the prior art, designed as remote controls, for manoeuvring drive systems. Specifically, for example, if the app is selected, keys are shown on the touchscreen of the smartphone or the tablet PC by means of which the control of a vehicle, which is equipped with a manoeuvring drive system according to the invention, can be performed easily. By pressing one of the keys, for example, a forwards or backwards motion in a straight line or cornering to the left or to the right in a forwards or backwards direction is brought about. For orientation, a diagrammatic representation of the vehicle, for example viewed from above, can be included on the control pad of the app in addition to the keys of the aforementioned type.

If an app is used, this can in particular also display how good the signal strength of the cable-free connection between the smartphone and the tablet PC and the communication module is.

Preferably a smartphone or a tablet PC which is Bluetooth-compatible is used here. A plurality of the smartphones and tablet PCs available on the market are already equipped with a Bluetooth transmitter and receiver as standard. If a communication module which is Bluetooth-compatible is used within the framework of the kit according to the invention, the user can directly control the drive units with his/her Bluetooth-compatible smartphone or tablet PC without any extension of the smartphone or tablet PC hardware being required for this purpose. He/she simply downloads an appropriate app, installs the latter and can easily manoeuvre a vehicle which is equipped with a manoeuvring drive system and with the kit according to the invention via his/her smartphone or his/her tablet PC.

The use of a smartphone or a tablet PC to control the drive units also offers the great advantage that one can entirely dispense with the use of an operating device of the conventional type in the form of a remote control. In particular when additional devices are provided on or around the vehicle and which can be controlled wirelessly, in particular via Bluetooth, a single smartphone or a single tablet PC with different apps can be used which then replaces all remote controls.

According to the invention any type of mobile telephone on which applications, i.e. apps, can be installed and implemented can be used as a smartphone. Any computer that can easily be held in the hand and on which apps can be used and which supports a wireless communication connection can be used as a tablet PC.

Another advantageous embodiment of the kit according to the invention is additionally characterised in that the connection means comprise at least one cable and at least one plug, the at least one plug being designed to be inserted into at least one socket provided on the control device and so to connect the communication module communicatively to the control device. A cable provided with appropriate plugs is an appropriate means for connecting the communication module on the outside of the vehicle and the control device in the vehicle interior to one another communicatively.

Furthermore, the communication module can be designed such that data can be sent by the latter cable-free. According to this configuration, not only can manoeuvring commands for the drive units be received from the communication module, but the latter is configured such that it can also send data. For example, condition data which are available in the control device, such as for example the charge level of the battery by means of which the drive units are supplied with electrical energy, or other condition data, can be sent to the operating device and can be visualised by the latter for the user. If a smartphone is used as an operating device, condition data can be visualised within the framework of the app.

Other subject matter of the present invention is a manoeuvring drive system for a vehicle, in particular a vehicle without its own drive, comprising:

at least two drive units which are designed to be provided on the vehicle and to drive a respective wheel of the vehicle,

a control device which is connected communicatively to the drive units and is configured to control the drive units,

a kit according to the present invention, the communication module being connected to the control device via the connection means so that the commands received cable-free from the communication module for control of the drive units can be transmitted to the control device.

According to one embodiment of the manoeuvring drive system according to the invention provision is made such that the connection means of the kit comprise at least one cable and at least one plug and the control device has at least one socket which is configured such that the at least one plug can be inserted into the latter in order to connect the communication module to the control device of the manoeuvring drive system.

In a further development provision is made, furthermore, such that each drive unit comprises a rotatably mounted drive element which is designed and arranged such that it can be brought into contact with a wheel of the vehicle in order to drive the vehicle.

Finally, subject matter of the present invention is a vehicle, in particular a vehicle without its own drive, comprising a manoeuvring drive system, the communication module being fastened to the vehicle, in particular to the outside of the vehicle, and preferably to the bottom of the vehicle, by fastening means.

In a further development of the vehicle according to the invention provision is made such that the control device is provided in the interior of the vehicle and the communication module is provided on the outside of the vehicle and the connection means comprise at least one cable which extends through an opening in a vehicle wall, in particular through an opening in the vehicle floor. The control device in the interior and the communication module on the outside of the vehicle are connected communicatively here by the cable passed through the opening.

The vehicle according to the invention can be, for example, a trailer. The kit according to the invention and the manoeuvring drive system according to the invention can in principle be used on all vehicles, in particular on all vehicles which do not have their own drive. Trailers are specified as examples of a vehicle without its own drive. Trailers can be, for example, caravans, boat or horse trailers.

### BRIEF DESCRIPTION OF THE DRAWINGS

Additional features and advantages of the present invention will become clear from the following description of an embodiment of the kit according to the invention with reference to the attached drawings.

The drawings show as follows:

FIG. 1 a diagrammatic representation of a caravan in which a manoeuvring drive system according to the invention is fitted,

FIG. 2 a diagrammatic representation of a communication module according to the invention which is connected to the control device of the manoeuvring drive system by a cable, and

FIG. 3 a diagrammatic representation of a smartphone with an app which makes it possible for a user to control, cable-free, the manoeuvring drive system.

### DETAILED DESCRIPTION OF THE PREFERRED EMBODIMENT(S)

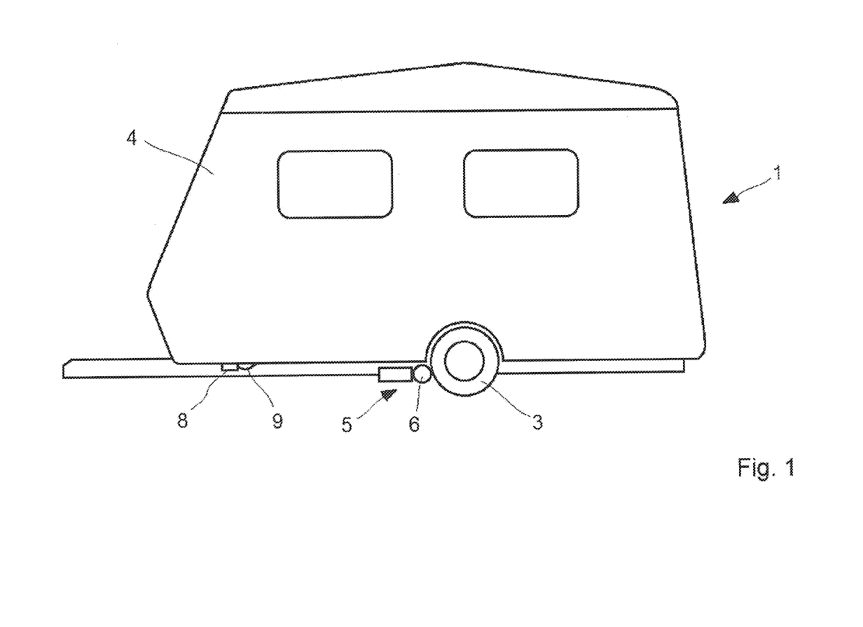

In a diagrammatic representation, FIG. 1 shows the side view of a caravan 1. The caravan 1 comprises a chassis 2 with an axle on which two wheels 3 are provided. In the view shown in FIG. 1 one can only see the wheel 3 of the caravan 1 which is on the left in the direction of travel. A caravan unit 4 is fitted to the chassis 2. In the interior of the caravan unit 4 there are various fittings including a bed, a seat and a table which can not be seen in the exterior view shown in FIG. 1.

If the caravan 1, like the one shown in FIG. 1, is not connected to a car serving as a towing vehicle, it is hard to manoeuvre manually. Therefore the caravan 1 is equipped with a manoeuvring drive system according to the invention. The latter comprises two drive units 5 of which, in the side view shown in FIG. 1, only the one fitted on the wheel 3 provided on the left in the direction of travel can be seen. The wheels 3 of the caravan 1 can be set in rotation by the two drive units 5.

For this purpose the drive units 5 are fitted on the outside in a region located in front of the wheels 3 in the direction of travel. Each of the two drive units 5 respectively comprises a drive element 6 which is designed and arranged such that it is brought into contact with the corresponding wheel 3 of the caravan 1 in order to drive the latter. Specifically, the drive unit 5 is arranged on the caravan 1 such that the drive element 6, which is in the form of a roller, can be brought into frictionally engaged contact with the respective wheel 3. The drive units 5 each comprise a motor, not visible in FIG. 1, by means of which the respective drive element 6 can be set in rotation in the clockwise or in the anticlockwise direction.

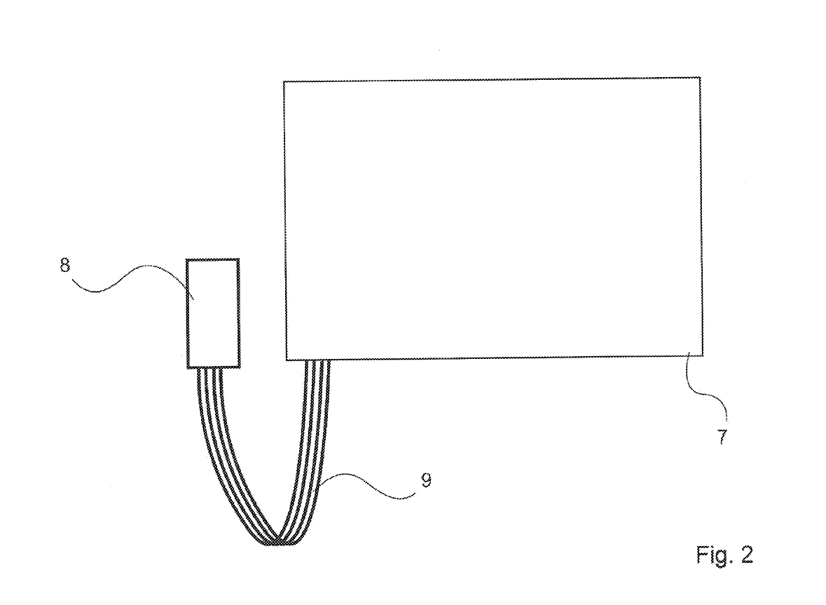

The manoeuvring drive system further comprises a control device 7, shown in FIG. 2, which is connected to the drive units 5 and is configured to control the drive units 5. Specifically, the motors which set the drive elements 6 in rotation are controlled by the control device 7. The control device 7 is fastened in the interior of the caravan unit 4, specifically in a seat provided in the latter. This can not be seen in the exterior view in FIG. 1. Each of the two drive units 5 is connected by another cable to the control device 7 by a respective cable. Furthermore, the control device is connected to a battery provided in the caravan 1 in order to supply the latter with voltage. The drive units 5 are also fed by the battery.

Finally, the manoeuvring drive system comprises a kit according to the invention with a communication module 8. The communication module 8 is designed to receive the commands for control of the drive units 5 cable-free via Bluetooth and to send data cable-free via Bluetooth. For this purpose the communication module 8 comprises a Bluetooth transmitter and a Bluetooth receiver. In the embodiment shown the communication module 8 has a temperature- and weather-resistant housing which is fastened to the caravan 1, specifically to the bottom of the caravan unit 4, from the outside by means of screws. The housing protects the electronics of the communication module 8 from high or low temperatures and moisture.

Furthermore, the kit according to the invention has a cable 9 by means of which the communication module 8 fastened to the bottom of the caravan unit 4 of the caravan 1 is communicatively connected to the control device 7 provided in the interior of the caravan unit 4. The cable serves not only to transfer data, but also to supply voltage to the communication module 8 via the battery which is connected to the control device 7. As can be seen in the enlarged illustration shown in FIG. 2, in which the control device 7 connected to the communication module 8 is shown in the non-fitted sate, the cable 9 comprises a total of four wires. The cable 9 extends through a hole provided in the bottom of the caravan unit 4 in order to guarantee connection to the control device provided in the interior of the caravan unit 4. The control device 7 comprises a socket that can not be seen in FIG. 2 and into which a plug provided on the cable 9 is inserted. On the communication module side the cable extends 9 directly into the module 8. Alternatively, the connection between the cable 9 and the communication module 8 can also be made by means of an appropriate plug.

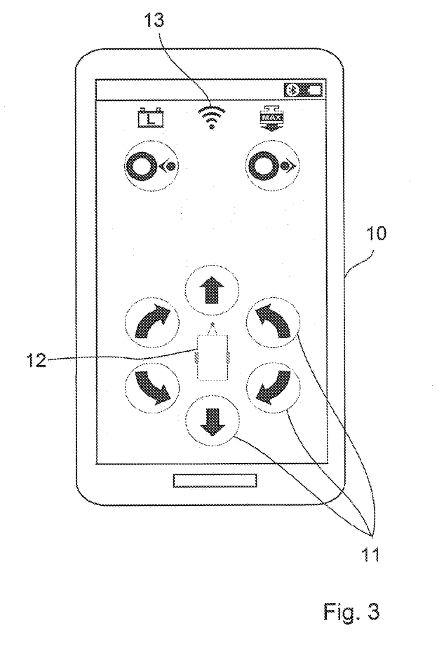

Moreover, the kit comprises an operating device shown in FIG. 3 which is designed such that a user can input commands for control of the drive units 5 into the operating device and that the inputted commands can be transmitted, cable-free, to the communication module 8 via Bluetooth. In the exemplary embodiment shown the operating device is formed by a Bluetooth-compatible smartphone 10.

Finally, an app, i.e. application software for the smartphone, is a component part of the kit which is designed to make it possible for a user to control, cable-free, the drive units 5 via the smartphone. The app is installed on the smartphone 10. Specifically, the app is configured such that the latter simulates the control pad of a conventional remote control on the touchscreen of the smartphone when it is activated, as shown in FIG. 3. Keys 11 are shown here by means of which the caravan 1 is easily controlled. Specifically, keys 11 are provided which can bring about forwards and backwards motion in a straight line and cornering to the left or to the right in a forwards or backwards direction. Furthermore, a diagrammatic representation 12 of the caravan 1 is included on the control pad of the app in the middle of the keys for orientation. Moreover, it is displayed by the control pad of the app, specifically by means of a signal strength display 13, how good the signal strength of the cable-free connection between the smartphone 10 and the communication module 8 currently is, i.e. at the position at which the user with the smartphone 10 is located in the vicinity of the caravan 1.

If the user wishes to manoeuvre his/her caravan 1, he/she presses the keys 11 shown when the app is selected on his/her touchscreen according to the desired motion which the manoeuvring drive is to bring about for the caravan 1. The manoeuvring commands corresponding to the respective key commands are conveyed cable-free via Bluetooth from the Bluetooth-compatible smartphone 10 to the communication module 8 provided on the outside of the caravan 1. The communication module 8 transmits the commands by cable via the cable 9 with which it is connected to the control device 7 provided in the interior of the caravan 1 to the control device 7. This in turn forwards the commands to the drive units 5 via the corresponding cables. The motors of the drive units 5 are controlled according to the commands received so that the drive elements 6, which are connected, frictionally engaged, to the wheels 3 of the caravan 1, are set in rotation in a forwards or backwards direction according to the user's command.

As a result, the caravan 1 is controlled by the manoeuvring commands inputted into the smartphone 10.

By using the kit according to the invention, which comprises a communication module 8 fastened to the outside of the caravan 1, it is guaranteed here at all times that the manoeuvring commands sent, cable-free, from the smartphone 10 reach the communication module 8. According to the invention, screening by the housing of the caravan unit 4 is prevented.

Since the user uses his/her smartphone 10, he/she can dispense with an additional remote control. If additional devices to be controlled cable-free by means of a remote control are provided on the caravan, he/she can use his/her smartphone 10 for this purpose, and so one can avoid using a plurality of different remote controls.

It will be apparent to one of ordinary skill in the art that various modifications and variations can be made in construction or configuration of the present invention without departing from the scope or spirit of the invention. Thus, it is intended that the present invention cover all such modifications and variations, and as may be applied to the central features set forth above, provided they come within the scope of the following claims and their equivalents.

1. A kit for the cable-free control of a manoeuvring drive system for a vehicle (1), in particular a vehicle (1) without its own drive, the manoeuvring drive system having at least two drive units (5) and a control device (7) connected to the drive units (5), comprising:
a communication module (8) which is designed to receive and/or transmit commands for control of the drive units (5) in a cable-free manner,
fastening means for fastening the communication module (8) to the vehicle (1), in particular on the outside of the vehicle (1), and preferably on the bottom of the vehicle (1), and
connection means for connecting the communication module (8) to the control device (7) so that the commands received, cable-free, for control of the drive units (5) can be transmitted from the communication module (8) to the control device (7).

2. The kit according to claim 1, characterised in that the communication module (8) is designed to receive and/or transmit the commands for control of the drive units (5) in a cable-free manner in particular via Bluetooth.

3. The kit according to claim 9 1, characterised in that a temperature- and/or weather-resistant housing is assigned to the communication module (8).

4. The kit according to claim 1, further comprising an operating device which is designed such that a user can input commands for control of the drive units (5) into the operating device and that the inputted commands are transmitted, cable-free, to the communication module (8), the operating device being designed in particular to transmit the inputted commands to the communication module (8) via Bluetooth.

5. The kit according to claim 1, further comprising an app for a smartphone or a tablet PC which is designed to enable a user to control the drive units (5), wireless, via a smartphone or a tablet PC.

6. The kit according to claim 3, further comprising an app for a smartphone or a tablet PC which is designed to enable a user to control the drive units (5), wireless, via a smartphone or a tablet PC.

7. The kit according to claim 1, characterised in that the connection means comprise at least one cable (9) and at least one plug, the at least one plug being designed to be inserted into at least one socket provided on the control device (7) and so to connect the communication module (8) to the control device (7).

8. The kit according to claim 5, characterised in that the connection means comprise at least one cable (9) and at least one plug, the at least one plug being designed to be inserted into at least one socket provided on the control device (7) and so to connect the communication module (8) to the control device (7).

9. The kit according to claim 6, characterised in that the connection means comprise at least one cable (9) and at least one plug, the at least one plug being designed to be inserted into at least one socket provided on the control device (7) and so to connect the communication module (8) to the control device (7).

10. A manoeuvring drive system for a vehicle (1), in particular a vehicle (1) without its own drive, comprising:
at least two drive units (5) which are designed to be provided on the vehicle (1) and to drive a respective wheel (3) of the vehicle (1),
a control device (7) which is connected to the drive units (5) and is configured to control the drive units (5),
a kit according to claim 1, the communication module (8) being connected to the control device (7) via the connection means so that the commands received wireless from the communication module (8) for control of the drive units (5) can be transmitted to the control device (7).

11. The system according to claim 10, characterised in that the connection means of the kit comprise at least one cable (9) and at least one plug and the control device (7) has a at least one socket which is configured such that the at least one plug can be inserted into the latter in order to connect the communication module (8) to the control device (7) of the manoeuvring drive system.

12. The system according to claim 11, characterised in that each drive unit (5) comprises a rotatably mounted drive element (6) which is designed and arranged such that it can be brought into contact with a wheel (3) of the vehicle (1) in order to drive the vehicle (1).

13. A vehicle (1), in particular a vehicle (1) without its own drive, comprising a manoeuvring drive system according to claim 10, the communication module (8) being fastened to the vehicle (1), in particular to the outside of the vehicle (1), and preferably to the bottom of the vehicle (1), by fastening means.

14. The vehicle (1) according to claim 13, characterised in that the control device (7) is provided in the interior of the vehicle (1) and the communication module (8) is provided on the outside of the vehicle (1) and the connection means comprise at least one cable (9) which extends through an opening in a vehicle wall, in particular through an opening in the bottom of the vehicle.

15. The kit according to claim 2, further comprising an operating device which is designed such that a user can input commands for control of the drive units (5) into the operating device and that the inputted commands are transmitted, cable-free, to the communication module (8), the operating device being designed in particular to transmit the inputted commands to the communication module (8) via Bluetooth.

16. The kit according to claim 3, further comprising an operating device which is designed such that a user can input commands for control of the drive units (5) into the operating device and that the inputted commands are transmitted, cable-free, to the communication module (8), the operating device being designed in particular to transmit the inputted commands to the communication module (8) via Bluetooth.

17. The kit according to claim 2, further comprising an app for a smartphone or a tablet PC which is designed to enable a user to control the drive units (5), wireless, via a smartphone or a tablet PC.

18. The kit according to claim 3, further comprising an app for a smartphone or a tablet PC which is designed to enable a user to control the drive units (5), wireless, via a smartphone or a tablet PC.

19. The kit according to claim 4, further comprising an app for a smartphone or a tablet PC which is designed to enable a user to control the drive units (5), wireless, via a smartphone or a tablet PC.
